(19) United States
(12) Patent Application Publication
(10) Pub. No.: US 2008/0170817 A1
(43) Pub. Date: Jul. 17, 2008

(54) Bearing Assemly With Integrated Sensor System

(75) Inventor: Graham F. McDearmon, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 11/912,288

(22) PCT Filed: May 10, 2006
(86) PCT No.: PCT/US2006/018305

§ 371 Date: Oct. 22, 2007

Related U.S. Application Data
(60) Provisional application No. 60/679,515, filed on May 10, 2005.

(51) Int. Cl. F16C 19/38; F16C 19/52

(52) U.S. Cl. 384/448

(57) ABSTRACT

The bearing assembly with integrated sensor system includes a hub defining a bore for coupling with a shaft, a housing, and at least one row of rolling elements positioned between the hub and the housing allowing rotational motion therebetween while confining the hub axially and radially within the housing. It also includes at least one strain sensor element attached to the hub for measuring forces and moments applied to the shaft, which is electrically connected to a power source, and a device for transmitting a signal from the strain sensor element to a processor.

### CROSS-REFERENCE TO RELATED APPLICATIONS

This application claims priority to U.S. Provisional Application No. 60/679,515 filed May 10, 2005 entitled BEARING ASSEMBLY WITH INTEGRATED SENSOR SYSTEM and which is incorporated herein by reference.

### BACKGROUND ART

The present invention relates in general to sensor systems and, more particularly, to a sensor system integrated into a bearing assembly for measuring shaft forces and conditions, such as torque, bending moments, strain, rotation, vibration, and temperature.

It has always been difficult and expensive to measure shaft torque, bending moments, and strain in a rotating shaft. In many industries, knowledge of shaft torque is critical to the performance of device systems. For example, in the automotive industry knowledge of shaft torque is critical to power control and vehicle dynamic control systems.

Typically, shaft torque is measured by either sensing the actual shaft deflection caused by a twisting force, or by detecting the effects of this deflection. When under torque, the surface of a shaft experiences shear strain. Generally, strain gages are mounted on the shaft to measure the deflection of the shaft due to the shear strain, which corresponds to the torque on the shaft.

Many different types of strain gages are used to measure torque, such as metal foil, piezoresistive, capacitive, and magnetoelastic strain sensors. Early torque sensors consisted of mechanical structures fitted with strain gages. However, their high cost kept them from increased industrial acceptance. While more recently developed technology has provided devices for torque measurement with improvements over the early torque sensors, there is still a need for low cost, reliable, and accurate torque measurement.

### BRIEF DESCRIPTION OF THE DRAWINGS

In the accompanying drawings which form part of the specification:

FIG. 1 is a cross-sectional view of a first embodiment of the present invention with a shaft shown in broken lines.

FIG. 2 is a cross-sectional view of a second embodiment of the present invention with a shaft shown in broken lines.

FIG. 3 is a cross-sectional view of a third embodiment of the present invention with a shaft shown in broken lines.

FIG. 4A is an end view illustrating strain sensor element orientation along a shaft.

FIG. 4B is a plan view of plane X-Z of FIG. 4A illustrating strain sensor element orientation along the shaft.

FIG. 4C is a plan view of plane Y-Z of FIG. 4A illustrating strain sensor element orientation along the shaft.

FIG. 4D is an unwrapped view of an outside surface of the shaft illustrating strain sensor orientation.

Corresponding reference numerals indicate corresponding parts throughout the several figures of the drawings.

### BEST MODES FOR CARRYING OUT THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

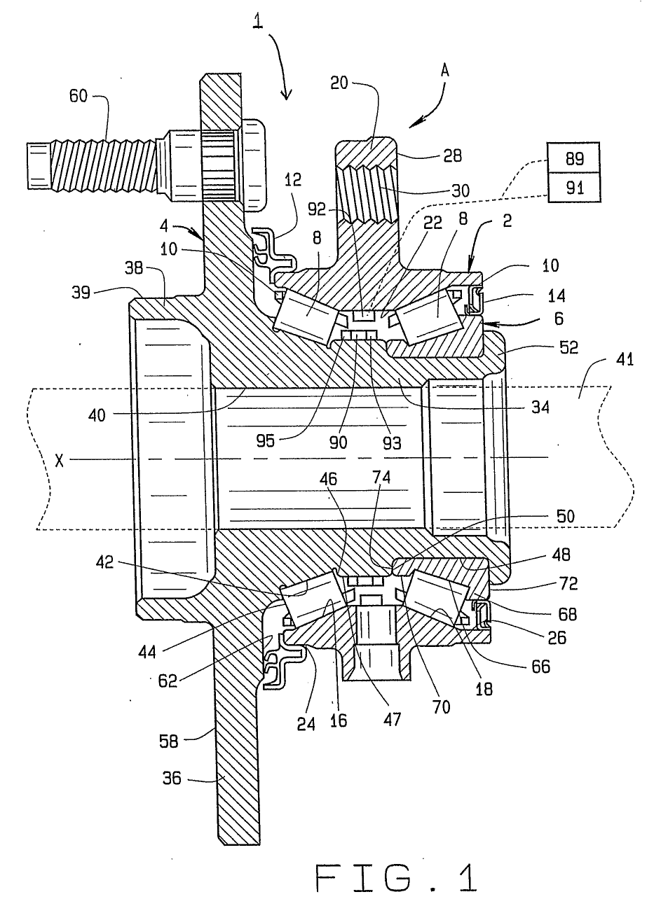

Referring to the drawings, FIG. 1 shows a first embodiment 1 of the present invention. The first embodiment 1 includes a production bearing assembly A, which accommodates rotation about an axis X. Bearing assembly A is similar to the bearing assembly described in U.S. Pat. No. 6,460,423, hereby incorporated by reference. While bearing assembly A is designed to couple the road wheel of an automotive vehicle to the suspension system of a vehicle, it may be used for other applications as well, such as power transmission applications. Those skilled in the art will recognize that other suitable bearing assemblies can also be used, such as ball bearings, spherical bearings, cylindrical bearings, and the like.

The bearing assembly A, includes a housing 2, a hub 4, an inner race 6 in the form of a cone, and rolling elements in the form of tapered rollers 8, which are located within the housing 2 and around the hub 4 and inner race 6 to facilitate rotation of the hub 4 and inner race 6 about the axis X with minimal friction. While the rollers elements of the present embodiment are illustrated as tapered rollers 8, other suitable rolling elements can also be used, such as ball bearings.

The housing 2 constitutes an outer bearing component, while the hub 4 and inner race 6 together form an inner bearing component. The rollers 8 are positioned between the housing 2 and the hub 4 and the inner race 6 in two rows of differing orientation, so that the rollers 8 confine the hub 4 and inner race 6 radially and axially in the housing 2, but do not offer any significant impediment to rotation. In addition, the bearing assembly A has cages 10 for separating the rollers 8 of the two rows. Finally, the assembly A has a seal 12 at the outboard end of the housing 2 and another seal 14 at the inboard end, each to retain a lubricant in and to exclude contaminants from the interior of the housing 2 and the rollers 8 in that interior. When the assembly A is installed on an automotive vehicle, the housing 2 is bolted to a suspension system component (not shown), such as a steering knuckle, while a brake disk and road wheel are attached to the hub 4. Thus, the bearing assembly A couples the road wheel to the suspension system component.

The housing 2 is preferably formed from bearing-grade steel having enough carbon to accept case hardening by induction heating. It has tapered raceways 16 and 18, which are presented inwardly toward the axis X and a generally triangular or rectangular flange 20, which projects outwardly away from the axis X. The two raceways 16 and 18 taper downwardly toward an intervening surface 22, which separates them. The raceway 16 opens out of the outboard end of the housing 2, and here the housing 2 has a seal-mounting surface 24. The other raceway 18 opens into an end bore 26, which in turn opens out of the inboard end of the housing 2. The flange 20 has an end face 28, which is machined perpendicular to the axis X, and threaded holes 30 which receive bolts for securing the housing 2 to a suspension system component with its end face 28 against the component.

The housing 2 is preferably formed by a forging or casting and is thereafter machined along the raceways 16 and 18 and along the seal mounting surface 24, the end bore 26, and the end face 28. The holes 30 are also bored and tapped. Then the housing 2 is induction heated along its raceways 16 and 18 and quenched to case harden the steel in those regions. Finally, it is ground along the raceways 16 and 18.

The hub 4 is likewise preferably formed from bearing grade steel, which is capable of being case hardened by induction heating. It includes a hub barrel 34 which projects axially through the housing 2, its center being the axis X, and a hub-mounting flange 36 which lies beyond the outboard end of the housing 2. In addition, the hub 4 has a wheel pilot 38 in the form of a circular rib which projects axially from the hub-mounting flange 36 and away from the hub barrel 34 and is machined on its outside surface and on its end face, the latter so as to lie in a plane perpendicular to the axis X. The hub 4 contains a bore 40, which extends completely through the hub barrel 34, opening at its outboard end into the wheel pilot 38. When assembled, the bore 40 couples with a shaft 41 or axle. In addition, the bore 40 may include a spline for engaging the spline on a stub axle, forming part of a constant velocity (CV) joint. While the first embodiment discloses a bore 40 for coupling with a shaft 41 with a circular cross-section, other embodiments of the bore 40 may accommodate shafts with cross-sections of other shapes such as, square or rectangular.

The hub barrel 34 has an outboard raceway 42, which is presented outwardly toward the outboard raceway 16 of the housing 2 and slopes in the same direction. The raceway 42 lies between a thrust rib 44 that is offset slightly from the mounting flange 36 and a retaining rib 46 of extended length, the large end of the raceway 42 being at the thrust rib 44 and the small end at the retaining rib 46. The intervening surface 22 of the housing 2 surrounds the outer diameter 47 of the retaining rib and beyond the rib 46, the hub barrel 34 has a inner race seat 48 of lesser diameter. The rib 46 and inner race seat 48 meet at a shoulder 50. At the other end of the seat 48, the hub barrel 34 turns outwardly in the provision of a formed end 52.

The mounting flange 36 around the pilot 38 has a machined surface 58 and lug bolts 60, which project beyond the machined surface 58. They pass through a brake disk and a wheel rim, both of which are secured to the flange 36 with lug nuts, which thread over the bolts 60. On its opposite face, the mounting flange 36 has a machined sealing surface 62, which is presented toward the inboard end of the housing 2.

The hub 4 is formed with the inboard end of its hub barrel 34 extended at essentially the same diameter as the inner race seat 48. In this condition the hub 4 is machined along the raceway 42, thrust rib 44, inner race seat 48, shoulder 50, and surfaces 58 and 62. Then it is induction heated along its raceway 42 and thrust rib 44 and quenched to provide the raceway 42 and rib with a hard case. Thereafter, it is ground along its raceway 42 and rib 44.

The inner race 6 is preferably formed from a bearing-grade steel which is heat treated to the necessary hardness. The inner race 6 fits over the inner race seat 48 on the hub barrel 34 of the hub 4 with an interference fit, and lies captured between the shoulder 50 and the formed end 52. It has (FIG. 1) a tapered raceway 66 that is presented outwardly toward the inboard raceway 18 of the housing 2 and slopes in the same direction, a thrust rib 68 at the large end of the raceway 66, and a retaining rib 70 at the small end. The thrust rib 68 runs out to a back face 72, whereas the retaining rib 70 ends at a front face 74, both of which are squared off with respect to the axis X. The front face 74 bears against the shoulder 50 on the hub barrel 34, whereas the formed end 52 bears against the back face 72.

The tapered rollers 8, which are likewise preferably formed from bearing grade steel, lie in two rows within the confines of the housing 2, there being an outboard row between the outboard raceway 16 of the housing 2 and the outboard raceway 42 on the hub barrel 34 of the hub 4 and an inboard row between the inboard raceway 18 of the housing 2 and the raceway 66 of the inner race 6. Contact exists between the tapered side surfaces of the rollers 8 in the outboard row and the raceways 16 and 18. The large end faces of these rollers 8 bear against the face of the thrust rib 44, which keeps the rollers 8 of the outboard row from being expelled from the interior of the housing 2. Likewise, contact exists between the tapered side faces of the rollers 8 of the inboard row and the raceways 18 and 66. The large end faces of the rollers 8 of the inboard row bear against the thrust rib 68 of the inner race 6, which keeps those rollers 8 from being expelled. The rollers 8 of each row are on apex, meaning that the conical envelopes for the rollers 8 of the row, will have their apices at a common point along the axis X. The spacing between the raceway 42 on the hub barrel 34 and the raceway 66 on the inner race 6 determines the setting of the bearing assembly A, and that is usually one of preload up to a few thousandths of an inch. Consequently, no radial or axial free motion exists between the housing 2 and the hub 4.

The outboard seal 12 fits over the mounting surface 24 on the exterior of the housing 2 and establishes a dynamic barrier along the sealing surface 62 on the mounting flange 36 of the hub 4. The inboard seal 14 fits into the end bore 26 of the housing 2 and around the thrust rib 68 of the inner race 6 where it establishes another dynamic barrier.

To assemble the bearing assembly A, one first installs the outboard row of rollers 8 and its cage 10 around the outboard raceway 42 of the hub barrel 34 on the hub 4. The housing 2, with the outboard seal 12 installed on its mounting surface 24, is advanced over the hub barrel 34 until its outboard raceway 16 seats against tapered side faces of the rollers 8 of the outboard row. Initially, the inner race seat 48 of the hub barrel 34 extends out to the very end of the hub barrel 34, it being somewhat longer than its final length in order to provide enough metal to produce the formed end 52. The inner race 6 is forced over the inner race seat 48 until the rollers 8 of the two rows seat firmly against their raceways 16, 42, and 18, 66. Then the portion of the hub barrel 34 which projects axially beyond the back face 72 of the inner race 6 is deformed in a rotary forming procedure to create the formed end 52. The rotary forming procedure holds the front face 74 of the inner race 6 tightly against the shoulder 50 of the hub barrel 34 so that the inner race 6 is captured between the shoulder 50 and the formed end 52. This not only brings the assembly A to its final setting, but also further permanently unitizes the bearing assembly A. International patent application PCT/GB98/01823, which was published under number WO98/58762, discloses a suitable rotary forming procedure.

The bearing assembly A may be unitized by other means as well. For example, a nut threaded over the end of the hub barrel 34 and against the back face 72 of the inner race 6 will serve to unitize the assembly. In addition, the raceway 42 need not be formed directly on the hub barrel 34 of the hub 4, but instead may be on another inner race. Moreover, the raceways 16 and 18 need not be formed directly on the housing 2, but may on separate races, called cups, that are pressed into the housing 2.

Strain sensor elements 90 are attached to the hub 4 along the retaining rib outer diameter 47 to measure forces applied to the shaft 41, such as, axial torque, bending moments, and axial force. It is important that the hub 4 is tightly coupled with the shaft 41 to efficiently couple strains between the shaft 41 and the hub 4. Typically, this requires a press fit between the bore 40 of the hub 4 and the shaft 41, but other alternatives are available. Locating the strain sensors 90 inside the bearing assembly protects them from environmental elements. In addition, the surface under the strain sensor 90 on the outer diameter 47 of the retaining rib 46 can be flattened by a suitable method, such as machining, to provide the benefits of easier, stronger bonding and reduced thermal effects. The strain sensors 90 can be attached to the hub 4 by any suitable method such as adhesives, welding, and eutectic alloy bonding.

The sensors 90 are electrically connected to a power source 89 such as a battery, by any suitable means including inductive coupling, RF power transmission, capacitive coupling, optical power, electric generator based on relative motion of the outer race and inner race or vibration, or slip rings. Similarly, a signal is transmitted from the sensors 90 to a processor 91 by any suitable means, such as including inductive coupling, RF power transmission, photonics, ultrasonics, capacitive coupling, or slip rings. The processor 91 processes the signals from the sensors 90 and converts the signals into useful data.

For example, one means to power the sensors 90 and transmit their signals includes a first antenna system 92 attached to the housing and electrically connected to the power source 89 and the processor 91, and a second antenna system 93 attached to the hub 4 and operatively connected to the first antenna system 92. The first antenna system 92 can be a coil of electrically conductive wire (with any number of turns) wound in a circumferential direction with respect to the inside surface of the housing (around, but not touching the axis of the hub), so that a generally axial magnetic flux emanates from the central region of the coil when energized electrically. The second antenna system 93 can be a coil of electrically conductive wire (with any number of turns) wound in a circumferential direction around and attached to the axis of the hub, so that a generally axial magnetic flux emanates from the central region of the coil when energized electrically. Alternatively, the coils of wire for both antenna systems 92 and 93 could be wrapped so that the direction perpendicular to their wrapping faces radially with respect to the axis X, so that a generally radial magnetic flux emanates from the center region of the coils when energized electrically. Alternating electrical current flowing through the first antenna system 92 will then inductively couple electrical power into the second antenna system 93, which can than be used to power and operate the sensors 90. Likewise, the signals from the sensors 90 can be formatted into an alternating current, which can be inductively coupled (or transmitted by RF telemetry) from the second antenna system 93 to the first antenna system 92. The signals are transferred from the first antenna system 92 to the processor 91 via an electrical connection, such as electrical wire, RF transmission, photonics, or ultrasonics.

In another embodiment, the means to power the sensors 90 and transmit their signals includes a slip ring, which are well known in the art, as represented by the first antenna system 92 attached to the housing 2 and the second antenna system 93 attached to the hub 4. Generally, a slip ring comprises a pair of conductive rings, represented by the first antenna system 92 and the second antenna system 93, mounted respectively on the hub 4 and the housing 2. Electrical connections, such as brushes, maintain contact between the rings 92 and 93 during rotation of the hub 4, thereby transferring electrical power or signals between the rings 92 and 93. However, those skilled in the art will recognize that any suitable type of slip ring can be used.

Those skilled in the art will recognize that any strain sensor technology can be used as a strain sensor element 90, such as, metal foil, piezoresistive, MEMS, vibrating wire, capacitive, inductive, optical, and ultrasonic. In addition, any variation of bridge sensor can be used such as, quarter bridge, half-bridge, or full-bridge. However, half-bridge and full-bridge sensors have reduced sensitivity to temperature. As a result, the sensors 90 are capable of determining forces applied to the shaft 41 while the shaft 41 is rotating or stationary.

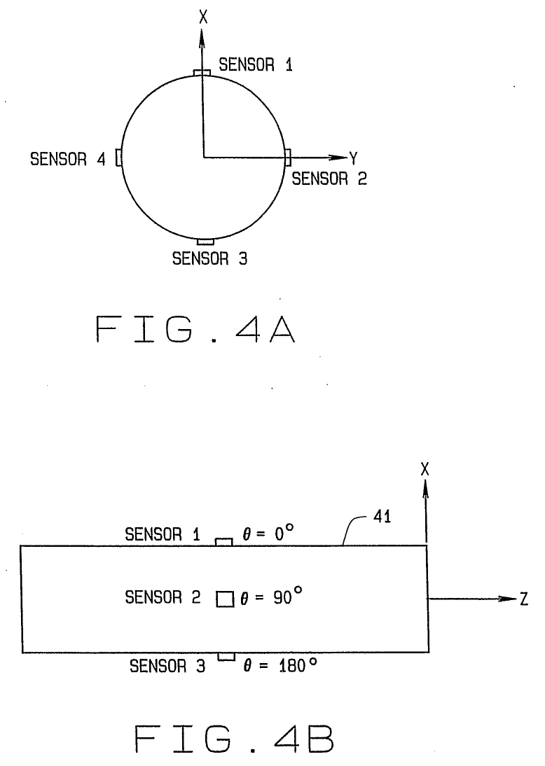

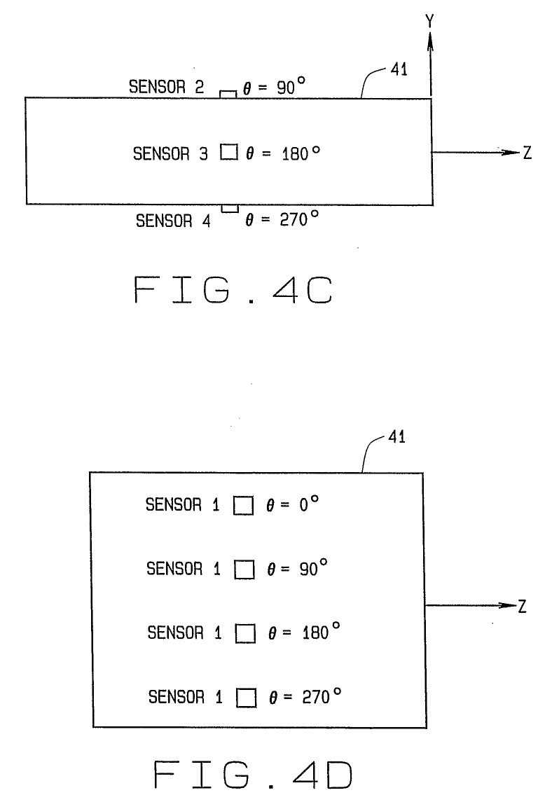

FIGS. 4A-4D illustrate the orientation of the strain sensor elements in the present invention. For easier understanding of strain sensor 90 orientation and operation, FIGS. 4A-4D do not show the bearing assembly. Instead, the strain sensors 90 are located directly on the shaft 41. However, the following description of strain sensor 90 orientation and operation is the same when the strain sensors 90 are located on the hub 4 or other bearing assembly parts.

As shown in FIG. 4A, the sensors 90 in the first embodiment are spaced at 90° intervals along a circumference of the shaft 41. The location of the four sensors 90 are indicated as the following: Sensor 1=0°, Sensor 2=90°, Sensor 3=180°, Sensor 4=270°. This orientation allows measurement of forces applied to the shaft 41 under varying conditions. Specifically, axial torque is measured differently depending on the presence of bending moments on the shaft 41. If bending moments on the shaft 41 are so low as to be negligible, then any one of the sensors 90 can measure the θz-component (cylindrical coordinates) of shear strain (S_{θz}) to provide a measurement of axial shaft torque (M_{z}). If the bending moments are not negligible, the axial shaft torque (M_{z}) and the bending moments can be measured at least three ways.

First, the sum of the measurements from two diametrically opposed (in-phase) sensors, such as sensors 1 and 3, provides a measurement of axial shaft torque (M_{z}), while reducing the influence of the shaft bending moment in the x-direction (M_{X}). Furthermore, the difference of the measurements from sensors 1 and 3, provides a measurement of the applied bending moment in the x-direction (M_{X}), while reducing the influence of the shaft axial shaft torque (M_{z}).

Second, the sum of the measurements from two diametrically opposed (in-phase) sensors, such as sensors 2 and 4, provides a measurement of axial shaft torque (M_{z}), while reducing the influence of the shaft bending moment in the y-direction (M_{Y}). Furthermore, the difference of the measurements from sensors 2 and 4, provides a measurement of the applied bending moment in the y-direction (M_{Y}), while reducing the influence of the axial shaft torque (M_{z}).

Third, the sum of the measurements from all four (in-phase) sensors provides a measurement of axial shaft torque (M_{z}), while reducing the influence of the shaft bending moments in the x-direction (M_{X}) and y-direction (M_{Y}). Furthermore, the difference of the measurements from sensors 1 and 3, provides a measurement of the applied bending moment in the x-direction (M_{X}), while reducing the influence of the axial shaft torque (M_{z}), and the difference of the measurements from sensors 2 and 4, provides a measurement of the applied bending moment in the y-direction (M_{Y}), while reducing the influence of the axial shaft torque (M_{z}).

In this orientation, the sensors 90 can be configured to provide a measurement of shaft bending moments and axial shaft force (F_{Z}) applied to the shaft 41. To do this, each sensor measures the axial strain (S_{z}) or the axial strain minus the circumferential strain (S_{z}-Sₑ). The difference of the measurements from strain sensors 1 and 3 provide a measurement of the bending moment in the y-direction (M_{Y}). The difference of the measurements from strain sensors 2 and 4 provide a measurement of the bending moment in the x-direction (M_{X}). The sum of the measurements from all four sensors, or the sum of the signals from sensors 1 and 3, or the sum of the measurements from sensors 2 and 4 provide a measurement of the axial shaft force (F_{Z}). It is important to note that strain sensors configured as differential pairs reduces the effects of temperature. In addition, other configurations of the sensors 90 can be used, including different numbers of sensors, locations, and orientations.

If desired, condition sensor elements 95 can measure other shaft conditions such as, temperature, rotation speed, and vibrations. The condition sensors 95 should be located in close proximity to the strain sensor elements 90 to allow correlation between shaft conditions and shaft forces. The condition sensors 95 can be attached to the hub 4 by any suitable method such as adhesives, welding, and eutectic alloy bonding. In addition, the surface under the condition sensor 95 on the outer diameter 47 of the retaining rib 46 can be flattened by a suitable method, such as machining, to provide the benefits of easier, stronger bonding and reduced thermal effects. Like the strain sensors 90, the condition sensors 95 can determine shaft conditions while the shaft 41 is rotating or stationary. If needed, the condition sensors 95 can be powered and transmit signals to the power source 89 and processor 91 by any of the appropriate means disclosed above for strain sensor elements 90, such as first antenna system 92 and second antenna system 93, slip rings, inductive coupling, RF power transmission, photonics, ultrasonics, or capacitive coupling. However, those skilled in the art will recognize that the condition sensors 95 can also be powered and transmit signals independently of the strain sensor elements 90.

In the first embodiment 1, the condition sensor element 95 is a temperature sensor. Consequently, the temperature information provided by the temperature sensor element 95 can be used to thermally compensate the strain sensor elements 90, as well as provide temperature information to the application. Those skilled in the art will recognize that the condition sensor 95 can also be a rotation speed sensor, and vibration sensor, or combination thereof.

Although FIG. 1 depicts the condition sensor element 95 as separate from the strain sensor element 90, alternate embodiments can use a single sensor module that combines the features of the strain sensor element 90 with the condition sensor element 95.

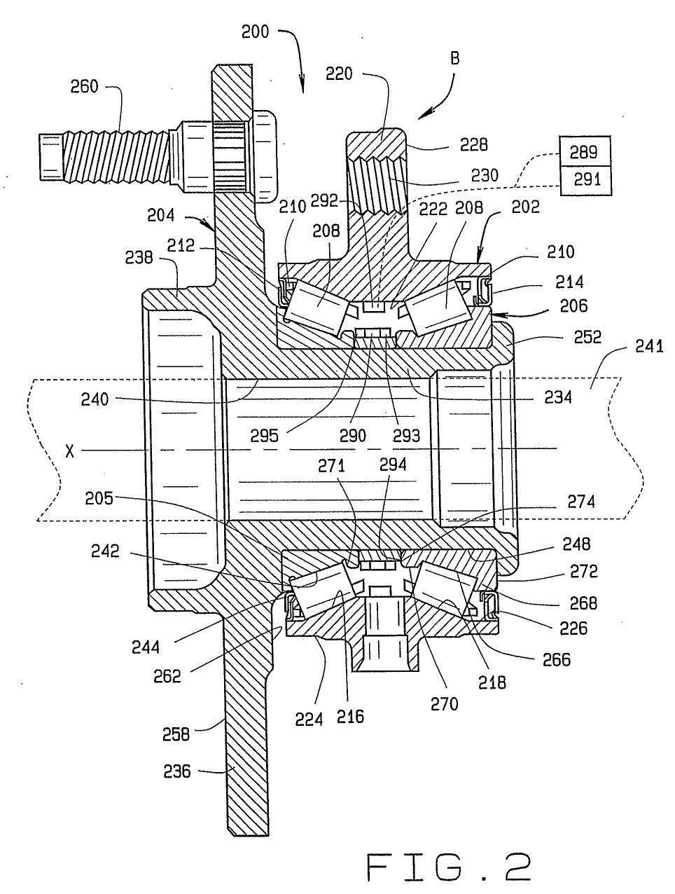

FIG. 2 depicts a second embodiment 201 of the present invention. The second embodiment 201 includes a production bearing assembly B, which accommodates rotation about an axis X. The second embodiment 201 is similar to the first embodiment 1, except for the addition of a second inner race 205 and a spacer 294. Elements that are the same have been renumbered using a 200 prefix. For example, hub 4 of the first embodiment 1 is renumbered hub 204 in the second embodiment 201.

The second inner race 205 seats within the inner race seat 248 oppositely inclined to the first inner race 206. The spacer 294 couples with the inner race seat 248 of the hub 204 juxtaposed with a retaining rib 270 of the first inner race 206 and the retaining rib 271 of the second inner race 205, thus, separating the first inner race 206 from the second inner race 205. Consequently, the spacer 294 determines the spacing between the first inner race 206 and second inner race 205. Therefore, the width of the spacer 294 can be varied to accommodate different size inner races. The spacer 294 is formed from the same bearing steel as the hub 204 or at least it should have the same modulus of elasticity that the steel of the hub 204 has at its inner race seat 248. It is important that the spacer 290 be tightly coupled with the hub 204 to effectively couple strains between the spacer 294 and the hub 204.

As a result of these differences, the mounting of the seal 212 at the outboard end is in a slightly different location. The outboard seal 212 fits over a mounting surface 224 on the interior of the housing 202 and establishes a dynamic barrier along a sealing surface 262 of the inner race 205.

The strain sensor elements 290 are attached along the spacer 294 to measure forces applied to the shaft 241 such as, axial torque, bending moments, and axial force. Other than attachment to the spacer 294 instead of the hub 204, the sensors 290 are identical to the sensors 90 of the first embodiment 1 in all other ways described above, including orientation and operation. Therefore, they will not be described any further here.

If desired, condition sensor elements 295 can measure other shaft conditions such as, temperature, rotation speed, and vibrations. The condition sensors 295 should be located in close proximity to the strain sensor elements 290 to allow correlation between shaft conditions and shaft forces. Other than attachment to the spacer 294 instead of the hub 204, the sensors 295 are identical to the sensors 90 of the first embodiment 1 in all other ways described above, including orientation and operation. Therefore, they will not be described any further here.

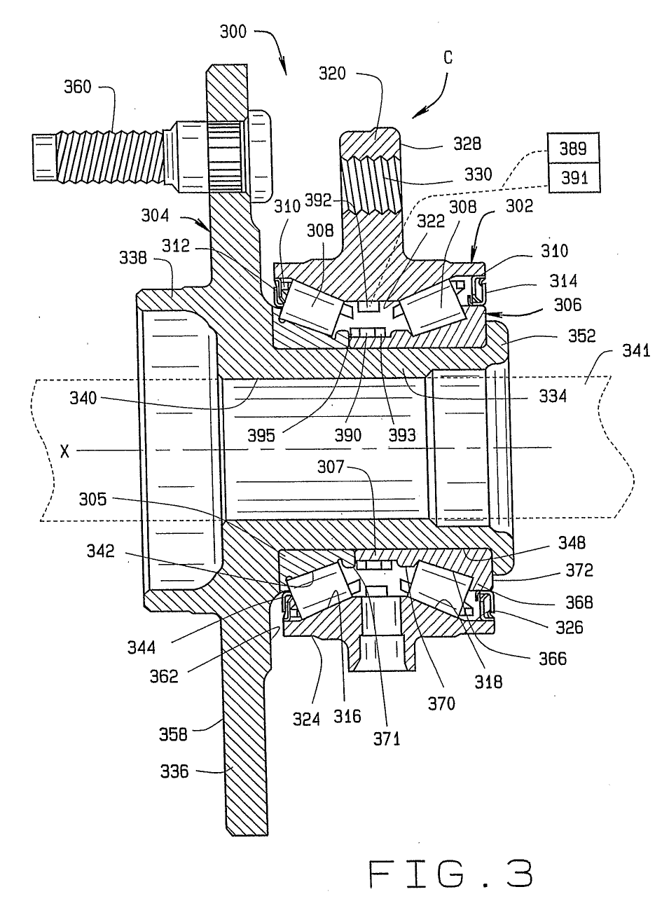

FIG. 3 depicts a third embodiment 301 of the present invention. The third embodiment 301 includes a production bearing assembly C, which accommodates rotation about an axis X. The third embodiment 301 is similar to the first embodiment 1, except for the addition of a second inner race 305 and an extended rib 307 on the first inner race 306. Elements that are the same have been renumbered using a 300 prefix. For example, hub 4 of the first embodiment 1 is renumbered hub 304 in the third embodiment 301.

The second inner race 305 seats within the inner race seat 348 oppositely inclined to the first inner race 306. The extended rib 307 of the first inner race couples with the inner race seat 348 of the hub 304 and is juxtaposed with a retaining rib 371 of the second inner race 305. It is important that the extended rib 307 of the first inner race 306 be tightly coupled with the hub 304 to effectively couple strains between the extended rib 307 of the first inner race 306 and the hub 304.

As a result of these differences, the mounting of the seal 312 at the outboard end is in a slightly different location. The outboard seal 312 fits over a mounting surface 324 on the interior of the housing 302 and establishes a dynamic barrier along a sealing surface 362 of the second inner race 305.

The strain sensor elements 390 are attached along the extended rib 307 to measure forces applied to the shaft 341 such as, axial torque, bending moments, and axial force. Other than attachment to the extended rib 307 instead of the hub 204, the sensors 390 are identical to the sensors 90 of the first embodiment 1 in all other ways described above, including orientation and operation. Therefore, they will not be described any further here.

If desired, condition sensor elements 395 can measure other shaft conditions such as, temperature, rotation speed, and vibrations. The condition sensors 395 should be located in close proximity to the strain sensor elements 390 to allow correlation between shaft conditions and shaft forces. Other than attachment to the spacer 394 instead of the hub 304, the sensors 395 are identical to the sensors 90 of the first embodiment 1 in all other ways described above, including orientation and operation. Therefore, they will not be described any further here.

Changes can be made in the above constructions without departing from the scope of the invention, it is intended that all matter contained in the above description or shown in the accompanying drawings shall be interpreted as illustrative and not in a limiting sense.

What is claimed is:

1. A bearing assembly with integrated sensor system comprising:
a hub defining a bore that couples with a shaft;
a first inner race coupled with the hub;
a second inner race coupled with the hub oppositely inclined to the first inner race;
a housing;
at least two rows of rolling elements positioned between the inner races and the housing allowing rotational motion between the housing and the hub, and confining the hub and inner races axially and radially within the housing; and
at least one strain sensor element attached to the hub for measuring forces applied to the shaft, the strain sensor element being operatively connected to a power source that delivers power to the strain sensor element and a processor that receives a signal from the strain sensor element.

2. The bearing assembly with integrated sensor system of claim 1, further comprising a spacer separating the first inner race from the second inner race, the spacer positioned between the hub and the at least one strain sensor to couple the forces therebetween.

3. The bearing assembly with integrated sensor system of claim 1, the first inner race having an extended rib juxtaposed with the second inner race, the extended rib being positioned between the hub and the at least one strain sensor element to couple the forces therebetween.

4. The bearing assembly with integrated sensor system of claim 1, further comprising four strain sensor elements attached to the hub and being spaced approximately equidistant along a circumference of the hub.

5. The bearing assembly with integrated sensor system of claim 1, further comprising two strain sensor elements attached to the hub at generally diametrically opposed locations.

6. The bearing assembly with integrated sensor system of claim 1, further comprising:
at least one condition sensor element attached to the hub for measuring at least one shaft condition, the condition sensor element being operatively connected to a power source that delivers power to the condition sensor element and a processor that receives a signal from the condition sensor element.

7. The bearing assembly with integrated sensor system of claim 6, wherein the shaft condition sensed by condition sensor element is selected from the group consisting of temperature, rotation speed, vibration, and any combination thereof.

8. The bearing assembly with integrated sensor system of claim 6, wherein the condition sensor element is integrated with the strain sensor element.

9. The bearing assembly with integrated sensor system of claim 5, wherein the condition sensor element comprises a temperature sensor capable of providing temperature data to the processor for thermal compensation of the strain sensor.

10. The bearing assembly with integrated sensor system of claim 1, further comprising:
a first antenna system attached to the housing and operatively connected to the power source and the processor, the first antenna system having a first coil of electrically conductive wire; and
a second antenna system attached to the hub and operatively connected to the strain sensor element, the second antenna system having a second coil of electrically conductive wire inductively coupled with the first coil of electrically conductive wire that transmits power and a signal between the first antenna system and the second antenna system.

11. The bearing assembly with integrated sensor system of claim 1, further comprising:
a slip ring coupled to the hub and the housing, the slip ring being operatively connected between the power source, the processor, and the strain sensor element.

12. A method of measuring forces on a shaft with a bearing assembly with integrated sensor system, the bearing assembly with integrated sensor system having a hub defining a bore that couples with a shaft, a first inner race coupled with the hub, a second inner race coupled with the hub oppositely inclined to the first inner race, a housing, at least two rows of rolling elements positioned between the inner races and the housing allowing rotational motion between the housing and the hub, and confining the hub and inner races axially and radially within the housing, the method comprising the steps of:
providing at least one strain sensor element attached to the hub, the strain sensor element being operatively connected to a power source that delivers power to the strain sensor element and a processor that receives a signal from the strain sensor element;
measuring forces applied to the shaft with at least one strain sensor;
transmitting a signal from the at least one strain sensor to the processor; and
processing the signal from the at least one strain sensor with the processor to determine axial torque on the shaft.

13. The method of measuring forces on a shaft with a bearing assembly with integrated sensor system of claim 12, further comprising the step of:
providing at least one condition sensor element attached to the hub;
sensing shaft conditions with the condition sensor element; and
transmitting a signal from the condition sensor element to the processor.

14. The method of measuring forces on a shaft with a bearing assembly with integrated sensor system of claim 12, wherein the shaft condition sensed by condition sensor element is selected from the group consisting of temperature, rotation speed, vibration, and any combination thereof.

15. The method of measuring forces on a shaft with a bearing assembly with integrated sensor system of claim 13, wherein the condition sensor element comprises a temperature sensor, further comprising the step of:
measuring temperature conditions of the shaft with the condition sensor element;
transmitting temperature data from the condition sensor element to the processor; and
processing the temperature data with the processor to thermally compensate the strain sensor element.

16. The method of measuring forces on a shaft with a bearing assembly with integrated sensor system of claim 12, further comprising the step of:
providing a spacer separating the first inner race from the second inner race, the spacer positioned between the hub and the at least one strain sensor to couple the forces therebetween.

17. The method of measuring forces on a shaft with a bearing assembly with integrated sensor system of claim 12, further comprising the step of:
providing an extended rib juxtaposed with the second inner race, the extended rib being positioned between the hub and the at least one strain sensor element to couple the forces therebetween.

18. The method of measuring forces on a shaft with a bearing assembly with integrated sensor system of claim 12, further comprising the step of:
providing four strain sensor elements attached to the hub, the four strain sensor elements and being spaced approximately equidistant along a circumference of the hub;
measuring forces applied to the shaft with the four strain sensor elements;
transmitting a signal from the four strain sensor elements to the processor; and
processing the signal from the four strain sensor elements with the processor to determine axial torque on the shaft.

19. The method of measuring forces on a shaft with a bearing assembly with integrated sensor system of claim 12, further comprising the step of:
providing two strain sensor elements attached to the hub at generally diametrically opposed locations;
measuring forces applied to the shaft with the two strain sensor elements;
transmitting a signal from the two strain sensor elements to the processor; and
processing the signal from the two strain sensor elements with the processor to determine axial torque on the shaft.

20. The method of measuring forces on a shaft with a bearing assembly with integrated sensor system of claim 12, further comprising the step of:
providing a first antenna system attached to the housing and operatively connected to the power source and the processor, the first antenna system having a first coil of electrically conductive wire; and
providing a second antenna system attached to the hub and operatively connected to the strain sensor element, the second antenna system having a second coil of electrically conductive wire inductively coupled with the first coil of electrically conductive wire; and
transmitting power and a signal between the first antenna system and the second antenna system.

21. The method of measuring forces on a shaft with a bearing assembly with integrated sensor system of claim 12, further comprising the step of:
providing a slip ring coupled to the hub and the housing, the slip ring being operatively connected between the power source, the processor, and the strain sensor element.
